(19) United States
(12) Patent Application Publication
(10) Pub. No.: US 2009/0287631 A1
(43) Pub. Date: Nov. 19, 2009

(54) Computer-Implemented Method and Computer System for Identifying Organisms

(75) Inventor: Stefan Emler, Zurich (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SmartGene GmbH, Zug (CH)

(21) Appl. No.: 12/084,608

(22) PCT Filed: Nov. 9, 2005
(86) PCT No.: PCT/CH2005/000664

§ 371 Date: May 6, 2008

(51) Int. Cl. G06N 5/04

(52) U.S. Cl. 706/54

(57) ABSTRACT

To identify organism types from a target gene sequence, a server receives (S1) a target reference from a user via a telecommunications network. From a plurality of type-specific profiles, defining informative sequence regions for differentiating individual organisms, selected (S2) automatically is a profile having a highest correlation with the target gene sequence. The target gene sequence is compared (S4) automatically to reference sequences related to the selected profile. The comparison results related to the informative sequence regions are weighted (S5) and, from the reference sequences, determined (S9) is the organism type associated with the type-specific reference sequence, having a best match with the target gene sequence. The best match is determined based on the weighted comparison results. The profile search and weighted alignment provides identification of organism types from a target gene sequence while discriminating between trivial and significant inter-sequence differences.

### CROSS-REFERENCE TO RELATED APPLICATIONS

This application is a national stage of PCT/CH2005/000664 filed Nov. 9, 2005, the disclosure of which is incorporated by reference herein.

### FIELD OF THE INVENTION

The present invention relates to a computer-implemented method and a computer system for identifying organisms.

### BACKGROUND OF THE INVENTION

Medical diagnostics increasingly rely on analysis of genetic targets of humans or microorganisms. Typically, this analysis is based on comparison of an individual target gene sequence to reference sequences from a reference database. The closest matching reference sequence is retrieved from the reference database. Thus, for identifying organism types from a target gene sequence, the conventional methods and systems compare and retrieve reference sequences with respect to their similarity with the target sequence. Conventionally, similarity is determined from overall matches over the longest common segment of target and reference sequence. Taken into account is the number of mismatches in a segment regardless of their positions. For example, in microbiology, the Ribosomal Database Project (RDP-II), accessible on http://rdp.cme.msu.edu/, the Ribosomal Differentiation of Microorganisms (RIDOM™), accessible on http://www.ridom.de/, and the European Ribosome RNA Database, accessible on http://www.psb.ugent.be/rRNA/, offer classification services based on bacterial 16S rDNA (ribosomal Deoxyribonucleic Acid) sequences. In these systems, used are methods that include the following steps: (i) match the target sequence against a reference database of 16S rDNA sequences, producing a set of closely matching sequences; (ii) build a multiple sequence alignment (MSA) from the target sequence and this set of reference sequences; (iii) extract a distance matrix from the MSA, and use this matrix to build an evolutionary tree; (iv) place the query sequence on the tree, and visualize the resulting relationships. However, these systems do not discriminate between inter-sequence differences that could be trivial in origin, e.g. due to sequencing errors or biologically unimportant variations, and those found in positions that are known to be diagnostic of inter-strain or inter-species differences. Consequently, in these systems, sequencing errors or random mutations at regions which are not significant have the same impact on sequence ranking as mismatches in certain variable regions related to genus or species, for example. As positions of these variable regions are not known before the organism type (e.g. genus, species, sub-type, variant or clade) of a given sample is identified, the sequence-comparison-based methodology is very user-dependent and requires a level of expertise one does not easily find in diagnostic labs.

### SUMMARY OF THE INVENTION

Aspects of the present invention relates to a computer-implemented method and a computer system for identifying organism types from a target gene sequence. An aspect of the present invention relates also to a computer program product for controlling the computer-based system such that the system executes the method of identifying organism types from the target gene sequence.

In accordance with aspects of the invention, a computer-implemented method and a computer system are provided for identifying organism types from a target gene sequence, an organism type including entity, genus, species, sub-type, variant and/or clade associated with the organism, which system and method do not have the disadvantages of the prior art. In accordance with particular aspects of the present invention, a computer-implemented method and a computer system are provided for identifying organism types from a target gene sequence, which system and method discriminate between trivial and significant inter-sequence differences. References made herein to the term “organism” or “organism type” shall be understood to include the terms “entity”, “genus”, “species”, “sub-type”, “group”, “strain”, “variant” and/or “clade” in the context of taxonomic classification.

In accordance with an aspect of the invention, organism types can be identified from a target gene sequence, selected automatically from a database is a selected profile having a highest correlation with the target gene sequence. The sequence profile can be selected from a plurality of type-specific profiles in the database, each profile defining informative sequence regions for differentiating individual organisms. Preferably, the type-specific profiles include genus-specific or group-specific profiles; moreover, the type-specific profiles may include species-specific, sub-type-specific, variant-specific, and/or clade-specific profiles. Reference sequences, related to the selected profile, can be retrieved automatically from the database. The target gene sequence can be compared automatically to the reference sequences and comparison results, related to the informative sequence regions, can be weighted automatically. Subsequently, from the reference sequences, a type-specific reference sequence can be determined which has a best match with the target gene sequence. The best match can be determined, for example, based on the comparison results weighted for the informative sequence regions. The type-specific reference sequence having the best match with the target gene sequence, considering the weighted comparison results, can be selected automatically or set as a top entry in a sorted list. Weighting for the informative sequence regions the comparison results makes it possible to identify the organism type from the target gene sequence while discriminating between trivial and significant inter-sequence differences. The results obtained through profile search and weighted alignment will provide a measurement reflecting correct assignment of organism type in bacteriology, mycology and virology. Consequently, the assignment of organism types, e.g. bacterial and fungal species or viral subtypes, is improved. Organism types can be assigned on the basis of not just statistical criteria but also on the basis of biologically relevant profiles. Consequently, more reliable results are derived for sequence analysis in an easy to use routine set-up. Generally, the time needed to produce results is shortened and the treatment of patients will benefit from more rapid and precise results.

In an embodiment, the comparison results include a number of differences and/or correspondences in nucleotide codes of each of the reference sequences when compared to the target gene sequence (nucleotide codes also including IUPAC (International Union of Pure and Applied Chemistry) codes). Weighting the comparison results can include determining for each reference sequence a weighted number of differences and/or correspondences by multiplying with a weighting factor the number of differences and/or correspondences related to the informative sequence regions. Furthermore, a list of the reference sequences can be stored, which can be sorted by the weighted number of differences and/or correspondences of the respective reference sequence.

In a preferred embodiment, the target gene sequence and the reference sequences related to the selected profile are assessed automatically for new informative sequence regions for the selected profile. Moreover, the selected profile can be adapted by storing a new informative sequence region as a part of the selected profile. Refining the sequence profile with newly identified informative sequence regions make it possible to consider evolutionary aspects of organisms, e.g. evolutionary relationships between species and strains. Continuous adaptation of sequence profiles help to adjust phylogenetic and ultimately taxonomic annotations and thus will provide important information to microbiologists and physicians with regard to the pathogenicity and epidemiology of unknown or misclassified microorganisms.

In an embodiment, assessing the target gene sequence and the reference sequences includes aligning the target gene sequence and the reference sequences related to the selected profile, and identifying new informative sequence regions. New informative sequence regions can be determined by identifying nucleotide codes corresponding at a same sequential position in at least a defined number of the target gene sequence and reference sequences.

Preferably, the type-specific profiles stored in the database can be determined by aligning type-specific gene sequences, by creating consensus sequences per organism type, by identifying the informative regions that enable differentiating the individual organism types, by adding sequence annotation information, and by defining the type-specific profiles based on the informative regions.

In an embodiment, the type-specific profiles stored in the database can include genus-specific or group-specific profiles. The genus-specific or group-specific profiles are determined by aligning genus-specific or group-specific gene sequences, by creating consensus sequences per organism, by identifying the informative regions that enable differentiating the individual organisms, and by defining the genus-specific or group-specific profiles based on the informative regions.

In a further embodiment, the target gene sequence can be proofread based on the selected profile by comparing the target gene sequence to the reference sequences related to the selected profile. For differences of nucleotide codes, located in informative sequence regions, it can be assessed whether the differences indicate another organism type. Adaptation of the selected profile can be initiated for differences assessed to indicate another organism type. Automatic proofreading based on the selected sequence profile makes it possible to proofread the target gene sequence while discriminating between trivial and significant inter-sequence differences.

Preferably, the target gene sequence is received by a server from a user via a telecommunications network. Furthermore, the organism type of the target gene sequence, which can be defined by the type-specific reference sequence, can be transmitted by the server via the telecommunications network to a user interface. Implementing the process on a network-based server makes it possible to provide efficiently (in terms of performance and financial costs) automatic identification of organism types from a target gene sequence as a centralized service, available to a plurality of users connected to the telecommunications network. Using a server-based technology for identifying organism types from a target gene sequence makes it possible for a user to use its own computer equipment without having to install any software or hardware. In the networked database, type-specific profiles can be added and improved continuously on the basis of target sequences supplied over the network by users. In addition, the reference sequence database, the software application, as well as any software tools can be updated online without any disturbance to users. Moreover, the network-based server can enable exchange and sharing of data between distant expert institutes as well as assessment of database entries representing organism types, e.g. bacterial and fungal species or viral subtypes, with respect to their taxonomic classification. Thus, the network-based server makes it possible for experts to re-evaluate and validate reference data sets for bacteria, mycobacteria, fungi, and viruses.

In addition to a computer-implemented method and a computer system for identifying organism types from a target gene sequence, in one embodiment a computer program product is provided which includes computer program code means for controlling one or more processors of the computer system such that the system executes the method of identifying organism types from a target gene sequence. Particularly, a computer program product including a computer readable medium containing therein the computer program code means (e.g. programmed software modules, as described later in more detail).

### BRIEF DESCRIPTION OF THE DRAWINGS

The present invention will be explained in more detail, by way of example, with reference to the drawings in which:

FIG. 1 shows a block diagram illustrating schematically an exemplary configuration of a computer system for practicing embodiments of the present invention, said configuration comprising a server with a database, and said configuration being connected to a data entry terminal via a telecommunications network.

FIG. 2 shows a flow diagram illustrating an example of a sequence of steps for establishing a sequence profile for a target organism.

FIG. 3 shows a flow diagram illustrating an example of a sequence of steps executed according to the present invention for identifying an organism type from a target gene sequence.

FIG. 4 shows a flow diagram illustrating an example of a sequence of steps executed according to the present invention for adapting sequence profiles based on a target gene sequence.

### DETAILED DESCRIPTION OF THE PREFERRED EMBODIMENTS

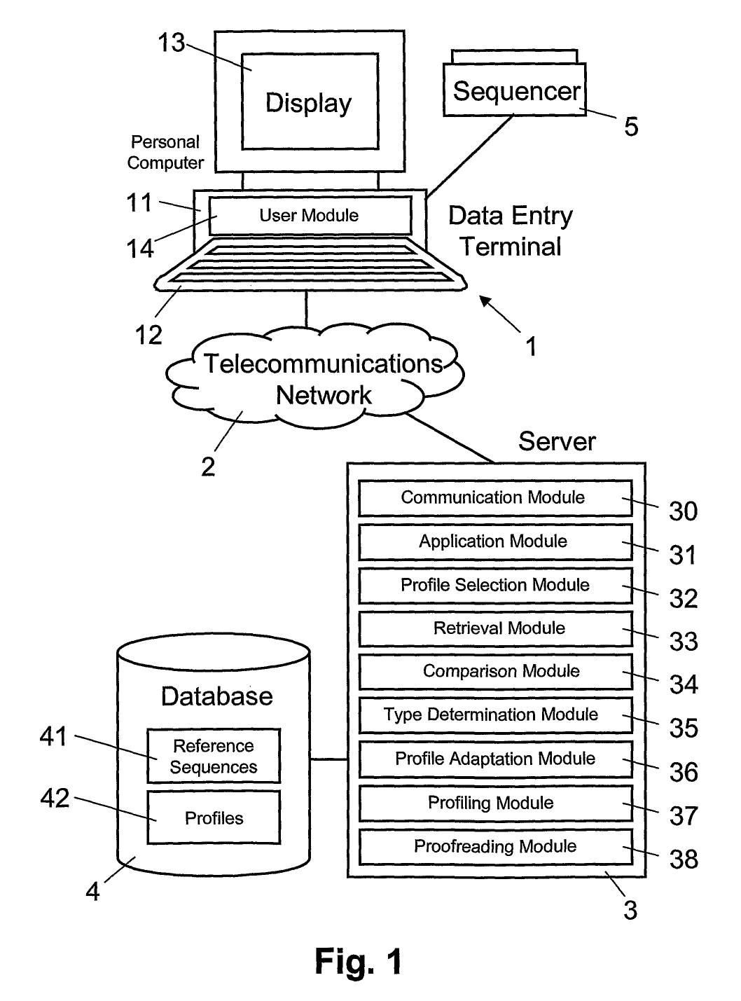

In FIG. 1, reference numeral 1 refers to a data entry terminal. As illustrated in FIG. 1, the data entry terminal 1 includes a personal computer 11 with a keyboard 12 and a display monitor 13. As is illustrated schematically, in an embodiment, the personal computer 11 includes a user module 14 implemented as a programmed software module, for example an executable program applet that is downloaded from server 3 via telecommunications network 2.

Connected to the personal computer 11 is a conventional sequencer 5, which provides the personal computer 11 with sequence data of DNA (Deoxyribonucleic Acid) fragments. For example, the fragment sequence data includes sequence signals and associated information (e.g. peak values) of the DNA fragments, each sequence signal including signals of the four nucleotide types Adenine, Cytosine, Guanine, and Thymine (A, C, G, T). Generally, the terms “gene sequence”, “target sequence”, or “reference sequence” are used herein to refer to a sequence of nucleotide codes, i.e. a sequence of codes, each representing one of the nucleotide types. The sequences are related to bacteria, fungi, microfungi, and viruses, for example.

As is illustrated in FIG. 1, the data entry terminal 1 is connected to server 3 through telecommunications network 2. Preferably, the telecommunications network 2 includes the Internet and/or an Intranet, making server 3 accessible as a web server through the World Wide Web or within a separate IP-network, respectively. Telecommunications network 2 may also include another fixed network, such as a local area network (LAN) or an integrated services digital network (ISDN), and/or a wireless network, such as a mobile radio network (e.g. Global System for Mobile communication (GSM) or Universal Mobile Telephone System (UMTS)), or a wireless local area network (WLAN). In a local embodiment, data entry terminal 1 is connected directly to server 3, or data entry terminal 1 and server 3 are implemented on the same computer, e.g. a PC.

As is illustrated schematically in FIG. 1, server 3 is connected to database 4. Server 3 may include one or more computers, each having one or more processors. The database 4 may be implemented on a computer shared with server 3 or on a separate computer.

The server 3 includes different functional modules, namely a communication module 30, an application module 31, a profile selection module 32, a retrieval module 33, a comparison module 34, a type determination module 35, a profile adaptation module 36, a profiling module 37, and a proofreading module 37. The communication module 30 includes conventional hardware and software elements configured for exchanging data via telecommunications network 2 with a plurality of data entry terminals 1. The application module 31 is a programmed software module configured to provide users of the data entry terminal 1 with a user interface. Preferably, the user interface is provided through a conventional Internet browser such as Microsoft Explorer or Mozilla. Alternatively, the user interface is generated by user module 14. For example, application module 31 transmits a copy of the user module 14 via telecommunications network 2 to the personal computer 11 of the user. The user module 14 is installed and activated on the personal computer 11. When activated, user module 14 controls a processor of the personal computer 11 such that it generates the user interface on display 13. The profile selection module 32, the retrieval module 33, the comparison module 34, the type determination module 35, the profile adaptation module 36, the profiling module 37, and the proofreading module 37 are programmed software modules executing on a computer of server 3.

As is illustrated schematically in FIG. 1, database 4 includes reference sequences 41 and associated sequence profiles 42 for different types of organisms. The profiles 42 are stored assigned to the reference sequences 41. Typically, more than one reference sequence 41 is assigned to a sequence profile 42. The profiles 42 define informative sequence regions for differentiating individual organisms, i.e. the profiles 42 include position-specific information related to one or more associated reference sequence 41 of a specific type of organism, i.e. a specific genus, species, sub-type, variant, and/or clade. The position-specific information is assigned to one specific position or to a range of multiple positions in a sequence. The range is defined, for example, by a start and an end position in the reference sequence or by a start position and a length (i.e. number of sequence positions). Alternatively, position-specific information may also be represented by means of Hidden Markov Models (HMM). While they are not identical, profiles 42 and HMM are sufficiently similar so that they will be used interchangeably in the present context. The sequence profiles 42 summarise the information contained in a multiple sequence alignment: the position-specific annotations document, for each position (column) in the alignment, the probability of finding a given residue (pattern) at that position, the cost of opening a gap in the alignment before or after this position (“open gap cost”), and the probabilities of finding particular residues immediately preceding or following the current position. As is illustrated in Table 1, in an embodiment, the profiles 42 are provided with additional information, e.g. the weight assigned to individual positions when calculating alignment scores, or structural parameters associated with ranges of positions.

TABLE 1

| Sequence Profile | | | | Assigned |
|---|---|---|---|---|
| Profile | Position-specific information | | | reference |
| identifier | Region/position | Annotation | Weighting | gene |
| | specification | | factor | sequence(s) |

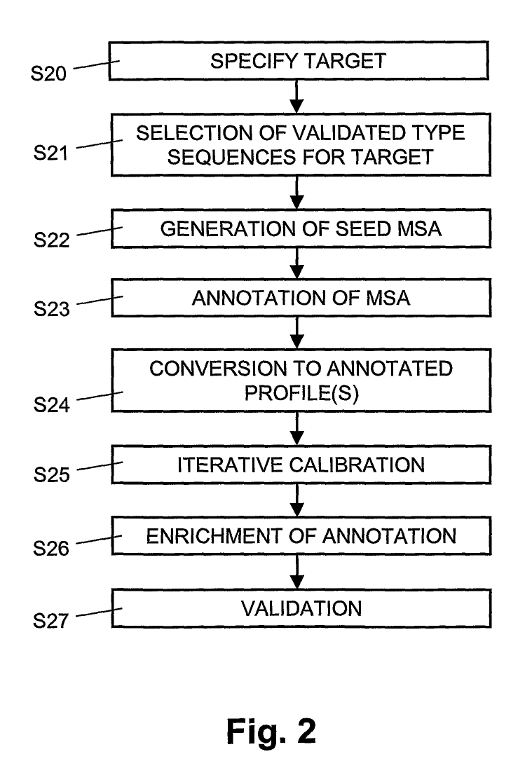

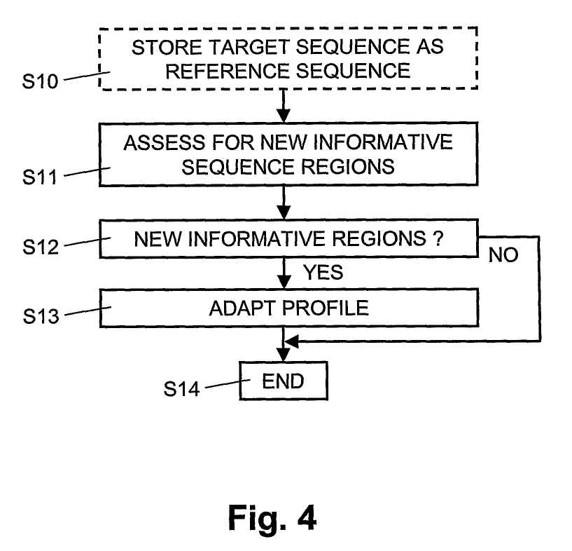

The initial profiles 42 are established and stored by profiling module 37, as will be described below with reference to FIG. 2. Further refinement and adaptation of the profiles is provided by profile adaptation module 36, as will be described later with reference to FIG. 4.

As is illustrated in FIG. 2, in step S20, a target organism or group of target organisms is specified. Preferably, the target organism is defined by a specific genus or species. However, one skilled in the art will understand that the target organism may be further defined by a sub-type, variant, and/or clade. The target is specified by a user through a user interface visualized on display 13 or on another data entry terminal connected to server 3. For example, the target is selected from a drop down list or entered in a data entry field. Alternatively, the target may also be selected automatically by the profiling module 37 from a list of possible targets.

In step S21, validated type sequences are selected for the target specified in step S20. For example, the validated gene sequences are selected automatically by the profiling module 37 from the reference sequences 41 in database 4. However, at least initially, the validated gene sequences are either retrieved from a validated reference database or selected and entered by an expert using data entry terminal 1. The validated type sequences for the specified target cover all the known variable positions, i.e. all the informative sequence regions (positions) that are known to be diagnostic of inter-strain or inter-species differences and thus indicative of organism types (including genus, species, sub-type, variant, and/or clade).

In step S22, using the profiling module 37, a seed MSA (multiple sequence alignment) is generated from the validated type sequences selected in step S21. Particularly, using the profiling module 37 the type sequences are aligned and a consensus sequence is created for the respective organism type.

In step S23, identified are informative regions that enable differentiating individual organism types. Using the profiling module 37, the MSA generated in step S22 is provided with annotations for secondary structures (3′ and 5′ pairing regions), and for positions known to be diagnostic for inter-strain or inter-species differences in the target organism, i.e. positions known to be indicative of organism types (including genus, species, sub-type, variant, and/or clade).

In step S24, the profiling module 37 converts the annotated MSA to one or more annotated profiles and stores these profiles 42 in database 4.

In step S25, using the profiling module 37, the profiles 42 stored in step S24 are calibrated iteratively. Iterative calibration is achieved by using the profile(s) to search a collection of reference sequences known (validated by experts) to belong or not to belong to the respective organism type, i.e. genus, species, sub-type, variant, and/or clade.

In step S26, using the profiling module 37, the annotation of the profiles 42 are enriched by including positions that discriminate between the target organism and other genera.

In step S27, the annotated profiles are validated by experts in the field and through statistics on available samples sequences. For validation purposes, the profiles 42 stored in database 4 are made available to the experts through server 3 and telecommunications network 2. For example, the validated profiles are provided with an indicator, or an electronic certificate or signature in database 4.

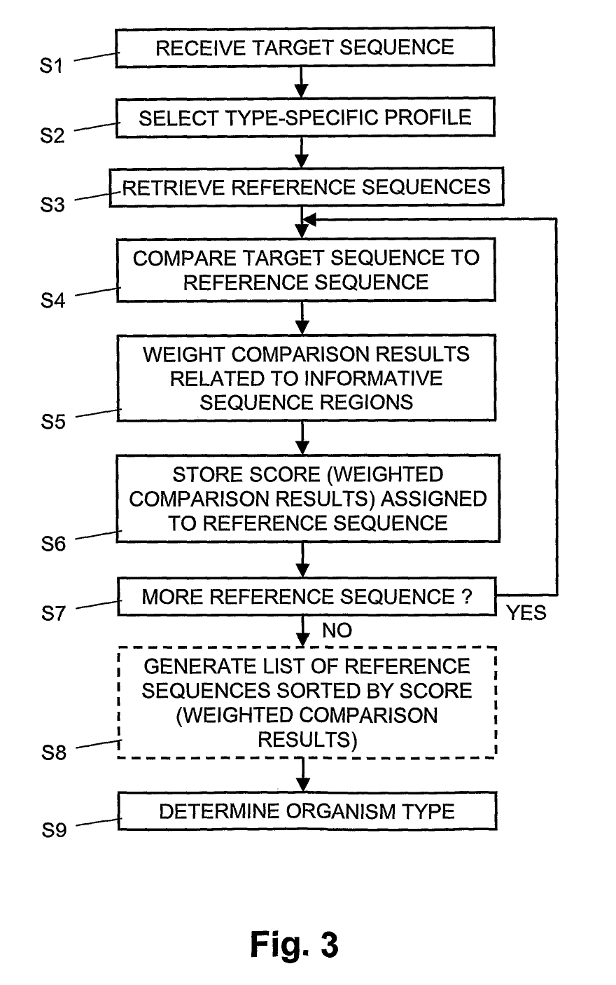

In the following paragraphs, the identification of an organism type from a target gene sequence is described with reference to FIG. 3.

In step S1, a target gene sequence is received by the communication module 30 via telecommunications network 2. The target gene sequence is provided by data entry terminal 1. For example, the target gene sequence is stored in personal computer 11 or generated from sequence data of DNA fragments provided by sequencer 5. Preferably, the target gene sequence is defined by a user through a user interface visualized on display 13 by application module 31 or by user module 14. Subsequently, the process for identifying the organism type is initiated automatically. Alternatively, the process is initiated by the user activating a control element such as a graphical button in the user interface.

In step S2, the profile selection module 32 determines in database 4 the sequence profile 42 having the highest correlation with the target gene sequence received in step S1. The degree of correlation between the target gene sequence and the sequence profiles 42 is determined based on the position-specific information contained in the sequence profiles 42, i.e. the profile selection module 32 uses the profile annotations on informative sequence regions to select the profile 42 having the best match with the target gene sequence. Preferably, the best matching sequence profile is determined by applying for each profile its position-specific weighting factors to deviations and/or correspondences of the target sequence from/with the profile.

In step S3, the retrieval module 33 loads from database 4 the reference gene sequences 41 associated with the sequence profile 42 selected in step S2.

In step S4, the comparison module 34 compares the target gene sequence, received in step S1, to one of the reference gene sequences, retrieved in step S3. Furthermore, the comparison module 34 weights the comparison results with weighting factors associated with the sequence profile, particularly, weighting factors associated with the informative sequence regions. Consequently, comparison results related to a first sequence region may be weighted with another weighting factor than comparison results related to another second sequence region. Thus, the comparison module 34 weights the number of differences and/or the number of correspondences, between the target gene sequence and the respective reference gene sequence, using weighting factors associated with the informative sequence regions outlined in the profile 42.

In step S6, the comparison module 34 stores a score, indicative of the matching level, assigned to the respective reference gene sequence. The score is based on the weighted comparison results. For example, comparison module 34 stores a score based on the weighted number of differences and/or correspondences.

In step S7, the application module 31 checks whether or not there are further reference gene sequences assigned to the selected profile that need to be processed. If there are more reference sequences to be processed, processing continues in step S4. Otherwise, if all reference sequences assigned to the selected profile have been processed, processing continues in step S8.

In optional step S8, the type determination module 35 generates a full or partial list of the reference sequences assigned to the selected profile. The list is sorted by the score assigned to the reference sequences. For example, the list (with its entries and assigned scores) is transmitted via telecommunications network 2 to the data entry terminal 1 where it is shown to the user on display 13.

In step S9, the type determination module 35 determines the type-specific reference gene sequence having the best match with the target gene sequence. The type determination module 35 determines the type-specific reference gene sequence based on the assigned scores, i.e. the weighted comparison results, e.g. the weighted number of differences and/or correspondences assigned to the reference sequences retrieved in step S3. For example, the type-specific reference gene sequence is defined by the lowest weighted number of differences and/or the highest weighted number of correspondences. The type information associated with the type-specific reference gene sequence is selected to define the organism type of the target gene sequence. Thus, the organism type of the target gene sequence is defined by the genus, species, sub-type, variant, and/or clade associated with the type-specific reference gene sequence. Preferably, the organism type and its assigned score are transmitted by the communication module 30 via telecommunications network 2 to the data entry terminal 1 where the organism type and its assigned score are shown to the user on display 13.

As is illustrated in FIG. 4, in an embodiment, subsequent to steps S1 to S9, the target gene sequence received in step S1 is used for refining the sequence profile 42 selected in step S2. In optional step S10, the profile adaptation module 36 stores the target gene sequence as a reference gene sequence in database 4, assigned to the profile 42 selected in step S2. In an embodiment, the target gene sequence is stored as a sample gene sequence in database 4. Refinement of the sequence profile 42 is triggered, for example, by a defined number of stored samples and/or statistics on stored samples and reference sequences.

In step S11, the profile adaptation module 36 assesses the new reference gene sequence from step S10, or one or more sample gene sequences stored in step S10, for new informative sequence regions. Particularly, the profile adaptation module 36 determines whether the reference gene sequences (and possibly sample gene sequences) assigned to the respective sequence profile 42 have informative sequence regions that are not yet included in the sequence profile but indicate an organism type, i.e. a genus, species, sub-type, variant, and/or clade. In essence, the profile adaptation module 36 determines sequence positions or regions that have a correlation across the respective reference gene sequences (and possibly sample gene sequences) exceeding a defined correlation threshold. For example, the profile adaptation module 36 aligns the new reference sequence (and possibly the sample gene sequences) and the reference sequences related to the selected profile, and identifies new informative sequence regions by identifying nucleotide codes corresponding at the same sequential position in at least a defined number of the new reference sequence (and possibly sample gene sequences) and reference sequences.

In step S12, the profile adaptation module 36 determines whether or not there is one or more new informative sequence region. If there are new informative sequence regions, processing continues in step S13. Otherwise, processing of the target gene sequence ends in step S14.

In step S13, based on the new informative sequence region(s) determined in step S11, the profile adaptation module 36 adapts the sequence profile selected in step S2. Thus, the sequence profile selected in step S2 is refined by adding the new informative sequence region(s) to the sequence profile. Subsequently, the refined sequence profile may be subject to iterative calibration and validation, as described in the context of steps S25 and S27.

The proofreading module 38 is configured to support proofreading of or proofread automatically the target gene sequence, received in step S1, based on the sequence profile, selected in step S2. To support a user in proofreading the target sequence, the proofreading module 38 indicates in a user interface any informative sequence regions that enable differentiation of organism type. Preferably, this indication is provided in an alignment of target sequence, reference sequence(s) and/or a consensus sequence, displayed in the user interface, by highlighting visually the informative sequence regions. To provide automatic proofreading, for differences arising from nucleotide codes located in informative sequence regions, indicative of organism types, the proofreading module 38 calculates values for the probability that the difference is due to an error in the target sequence or that the difference indicates another organism type. Furthermore, the proofreading module 38 applies threshold values to the calculated probability values and corrects automatically an error (e.g. in the consensus sequence), or inserts (into the consensus sequence) a special code indicating ambiguity, for example an IUPAC (International Union of Pure and Applied Chemistry) code, or triggers an adaptation of the sequence profile, as described above with reference to FIGS. 2 and 4.

In describing representative embodiments of the invention, the specification may have presented embodiments of a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the invention should not be limited to the performance of their steps in the order written, and one skilled in the art can readily appreciate that the sequences may be varied and still remain within the spirit and scope of the invention.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. Particularly, in addition to the sectors of bacteriology, mycology and virology, the present inventions can also be applied in any other sectors where sequence similarity searches are involved, e.g. in human and veterinary diseases and disease predispositions (e.g. cancer), in infectious diseases such as HBV, HIV etc., as well as in typing of animals, humans, plants, microorganisms and viruses, among others.

1. A computer-implemented method of identifying organism types from a target gene sequence, comprising:
selecting automatically in a database from a plurality of type-specific profiles, each profile defining informative sequence regions for differentiating individual organisms, a selected profile having a highest correlation with the target gene sequence;
retrieving automatically from the database reference sequences related to the selected profile;
comparing automatically the target gene sequence to the reference sequences and weighting automatically comparison results related to the informative sequence regions; and
determining from the reference sequences a type-specific reference sequence having a best match with the target gene sequence, the best match being determined based on the comparison results weighted for the informative sequence regions.

2. The method according to claim 1, wherein the comparison results include a number of differences in nucleotide codes of each of the reference sequences when compared to the target gene sequence; wherein weighting the comparison results includes determining for each reference sequence a weighted number of differences by multiplying with a weighting factor the number of differences related to the informative sequence regions; and wherein the method further includes storing a list of the reference sequences, the list being sorted by the weighted number of differences of the respective reference sequence.

3. The method according to one of claims 1 or 2, wherein the comparison results include a number of correspondences in nucleotide codes of each of the reference sequences when compared to the target gene sequence; wherein weighting the comparison results includes determining for each reference sequence a weighted number of correspondences by multiplying with a weighting factor the number of correspondences related to the informative sequence regions; and wherein the method further includes storing a list of the reference sequences, the list being sorted by the weighted number of correspondences of the respective reference sequence.

4. The method according to claim 1, wherein the target gene sequence and the reference sequences related to the selected profile are assessed automatically for new informative sequence regions for the selected profile; and wherein the selected profile is adapted by storing a new informative sequence region as a part of the selected profile.

5. The method according to claim 4, wherein assessing the target gene sequence and the reference sequences includes aligning the target gene sequence and the reference sequences related to the selected profile, and identifying the new informative sequence regions by identifying nucleotide codes corresponding at a same sequential position in at least a defined number of the target gene sequence and reference sequences.

6. The method according to claim 1, wherein the type-specific profiles stored in the database are determined by aligning type-specific gene sequences, by creating consensus sequences per organism type, by identifying the informative regions that enable differentiating the individual organism types, and by defining the type-specific profiles based on the informative regions.

7. The method according to claim 6, wherein the type-specific profiles stored in the database include genus-specific or group-specific profiles, and wherein the genus-specific or group-specific profiles are determined by aligning genus-specific or group-specific gene sequences, by creating consensus sequences per organism, by identifying the informative regions that enable differentiating the individual organisms, and by defining the genus-specific or group-specific profiles based on the informative regions.

8. The method according to claim 1, wherein the target gene sequence is proofread based on the selected profile by comparing the target gene sequence to the reference sequences related to the selected profile, by assessing for differences of nucleotide codes, located in informative sequence regions, whether the differences indicate another organism type, and by initiating adaptation of the selected profile for differences assessed to indicate another organism type.

9. The method according to claim 1, wherein the target gene sequence is received by a server from a user via a telecommunications network; and wherein the organism type of the target gene sequence, defined by the type-specific reference sequence, is transmitted by the server via the telecommunications network to a user interface.

10. A computer system for identifying organism types from a target gene sequence, the system comprising:
a database comprising a plurality of type-specific profiles, each profile defining informative sequence regions for differentiating individual organisms;
a profile selection module configured to select automatically from said profiles a selected profile having a highest correlation with the target gene sequence;
a retrieval module configured to retrieve automatically from the database reference sequences related to the selected profile;
a comparison module configured to compare automatically the target gene sequence to the reference sequences and weighting automatically comparison results related to the informative sequence regions; and
a type determination module configured to determine from the reference sequences a type-specific reference sequence having a best match with the target gene sequence, the best match being determined based on the comparison results weighted for the informative sequence regions.

11. The system according to claim 10, wherein the comparison results include a number of differences in nucleotide codes of each of the reference sequences when compared to the target gene sequence; wherein the comparison module is configured to determine for each reference sequence a weighted number of differences by multiplying with a weighting factor the number of differences related to the informative sequence regions; and wherein the type determination module is configured to store a list of the reference sequences, the list being sorted by the weighted number of differences of the respective reference sequence.

12. The system according to one of claims 10 or 11, wherein the comparison results include a number of correspondences in nucleotide codes of each of the reference sequences when compared to the target gene sequence; wherein the comparison module is configured to determine for each reference sequence a weighted number of correspondences by multiplying with a weighting factor the number of correspondences related to the informative sequence regions; and wherein the type determination module is configured to store a list of the reference sequences, the list being sorted by the weighted number of correspondences of the respective reference sequence.

13. The system according to claim 10, further comprising a profile adaptation module configured to assess automatically the target gene sequence and the reference sequences related to the selected profile for new informative sequence regions for the selected profile, and to adapt the selected profile by storing a new informative sequence region as a part of the selected profile.

14. The system according to claim 13, wherein the profile adaptation module is configured to align the target gene sequence and the reference sequences related to the selected profile, and to identify the new informative sequence regions by identifying nucleotide codes corresponding at a same sequential position in at least a defined number of the target gene sequence and reference sequences.

15. The system according to claim 10, further comprising a profiling module configured to determine the type-specific profiles stored in the database by aligning type-specific gene sequences, by creating consensus sequences per organism type, by identifying the informative regions that enable differentiating the individual organism types, and by defining the type-specific profiles based on the informative regions.

16. The system according to claim 15, wherein the type-specific profiles stored in the database include genus-specific or group-specific profiles, and wherein the profiling module is configured to determine the genus-specific or group-specific profiles by aligning genus-specific or group-specific gene sequences, by creating consensus sequences per organism, by identifying the informative regions that enable differentiating the individual organisms, and by defining the genus-specific or group-specific profiles based on the informative regions.

17. The system according to claim 10, further comprising a proof reading module configured to proofread the target gene sequence based on the selected profile by comparing the target gene sequence to the reference sequences related to the selected profile, to assess for differences of nucleotide codes, located in informative sequence regions, whether the differences indicate another organism type, and to initiate adaptation of the selected profile for differences assessed to indicate another organism type.

18. The system according to claim 10, further comprising a communication module configured to receive the target gene sequence from a user via a telecommunications network, and to transmit the organism type of the target gene sequence, defined by the type-specific reference sequence, via the telecommunications network to a user interface.

19. A computer program product comprising computer program code means for controlling one or more processors of a computer system, such that the system receives a target gene sequence;
selects in a database from a plurality of type-specific profiles, each profile defining informative sequence regions for differentiating individual organism types, a selected profile having a highest correlation with the target gene sequence;
retrieves from the database reference sequences related to the selected profile;
compares the target gene sequence to the reference sequences and weights comparison results related to the informative sequence regions; and
determines from the reference sequences a type-specific reference sequence having a best match with the target gene sequence, the best match being determined based on the comparison results weighted for the informative sequence regions.

20. The computer program product according to claim 19, comprising further computer program code means for controlling the processors of the computer system, such that the system includes in the comparison results a number of differences in nucleotide codes of each of the reference sequences when compared to the target gene sequence; determines for each reference sequence a weighted number of differences by multiplying with a weighting factor the number of differences related to the informative sequence regions; and stores a list of the reference sequences, the list being sorted by the weighted number of differences of the respective reference sequence.

21. The computer program product according to one of claims 19 or 20, comprising further computer program code means for controlling the processors of the computer system, such that the system includes in the comparison results a number of correspondences in nucleotide codes of each of the reference sequences when compared to the target gene sequence; determines for each reference sequence a weighted number of correspondences by multiplying with a weighting factor the number of correspondences related to the informative sequence regions; and stores a list of the reference sequences, the list being sorted by the weighted number of correspondences of the respective reference sequence.

22. The computer program product according to claim 19, comprising further computer program code means for controlling the processors of the computer system, such that the system assesses the target gene sequence and the reference sequences related to the selected profile for new informative sequence regions for the selected profile; and adapts the selected profile by storing a new informative sequence region as a part of the selected profile.

23. The computer program product according to claim 22, comprising further computer program code means for controlling the processors of the computer system, such that the system, in assessing the target gene sequence and the reference sequences, aligns the target gene sequence and the reference sequences related to the selected profile; and identifies the new informative sequence regions by identifying nucleotide codes corresponding at a same sequential position in at least a defined number of the target gene sequence and reference sequences.

24. The computer program product according to claim 19, comprising further computer program code means for controlling the processors of the computer system, such that the system determines the type-specific profiles stored in the database by aligning type-specific gene sequences, by creating consensus sequences per organism type, by identifying the informative regions that enable differentiating the individual organism types, and by defining the type-specific profiles based on the informative regions.

25. The computer program product according to claim 24, comprising further computer program code means for controlling the processors of the computer system, such that the system includes in the type-specific profiles, stored in the database, genus-specific or group-specific profiles; and determines the genus-specific or group-specific profiles by aligning genus-specific or group-specific gene sequences, by creating consensus sequences per organism, by identifying the informative regions that enable differentiating the individual organisms, and by defining the genus-specific or group-specific profiles based on the informative regions.

26. The computer program product according to claim 19, comprising further computer program code means for controlling the processors of the computer system, such that the system proofreads the target gene sequence based on the selected profile by comparing the target gene sequence to the reference sequences related to the selected profile; assesses for differences of nucleotide codes, located in informative sequence regions, whether the differences indicate another organism type; and initiates adaptation of the selected profile for differences assessed to indicate another organism type.

27. The computer program product according to claim 19, comprising further computer program code means for controlling the processors of the computer system, such that the system receives the target gene sequence from a user via a telecommunications network; and transmits via the telecommunications network to a user interface the organism type of the target gene sequence, defined by the type-specific reference sequence.
